(19) United States
(12) Patent Application Publication
(10) Pub. No.: US 2019/0292872 A1
(43) Pub. Date: Sep. 26, 2019

(54) Analyzer For A Blowout Preventer

(71) Applicant: HALLIBURTON ENERGY SERVICES, INC., Houston, TX (US)

(72) Inventors: Krishna Babu YERUBANDI, Houston, TX (US); Ravinder GAHLAWAT, Pune (IN); Shanu JAIN, Pune (IN); Venkata Gopala Rao PALLA, Pune (IN); Sean Chandler Jones, Houston, TX (US)

(73) Assignee: Halliburton Energy Services, Inc., Houston, TX (US)

(21) Appl. No.: 16/301,146

(22) PCT Filed: Jul. 11, 2016
(86) PCT No.: PCT/US2016/041728

§ 371 Date: Nov. 13, 2018

(51) Int. Cl. E21B 33/064; E21B 47/10; G05B 23/02

(52) U.S. Cl. CPC E21B 33/064; G05B 2219/45129; G05B 23/0254; E21B 47/1025

(57) ABSTRACT

A computing device can determine the integrity of a blowout preventer in a well system using a model generated from real-time sensor data. For example, the computing device can receive predetermined values associated with how pressure decays or otherwise changes in a pressurization subsystem overtime. The pressurization subsystem can be for pressurizing the blowout preventer. The computing device can also receive, from a pressure sensor, real-time pressure measurements indicating pressures in the pressurization subsystem. The computing device can generate the model based on the predetermined values and the pressure measurements. The computing device can use the model to predict the pressure in the pressurization subsystem during a future period of time. The computing device can analyze aspects of the predicted pressure in the pressurization subsystem over the future period of time to determine if the blowout preventer is functioning properly.

### TECHNICAL FIELD

The present disclosure relates generally to devices for use in well systems. More specifically, but not by way of limitation, this disclosure relates to analyzing and testing a blowout preventer in a well system.

### BACKGROUND

A well system (e.g., an oil or gas well for extracting fluid from a subterranean formation) can include a wellbore with a blowout preventer positioned at an opening of the wellbore. The blowout preventer can control the pressure within and the flow of fluid through the wellbore to prevent a blowout, which can include an uncontrolled release of fluid from the wellbore. Because a blowout can be catastrophic for the well system, damaging to the surrounding environment, and can present serious safety hazards to operators of the well system, it may be desirable to periodically test the blowout preventer to ensure the blowout preventer is functioning properly.

### BRIEF DESCRIPTION OF THE DRAWINGS

FIG. 1 is a cross-sectional side view of an example of a well system with a computing device for testing a blowout preventer according to some aspects.

FIG. 2 is a graph of an example of pressures in a blowout preventer during a test according to some aspects.

FIG. 3 is a block diagram of an example of a computing device for testing a blowout preventer according to some aspects.

FIG. 4 is a flow chart showing an example of a process for testing a blowout preventer according to some aspects.

### DETAILED DESCRIPTION

Certain aspects and features of the present disclosure relate to determining the integrity of a blowout preventer in a well system using a model generated from real-time sensor data. Some examples can be implemented using a computing device. The computing device can receive predetermined values associated with pressure changes over time in a pressurizing system for pressurizing the blowout preventer. The pressurizing system can be a closed system that includes a pump for pressurizing the blowout preventer, the blowout preventer, and one or more lines coupling the pump to the blowout preventer. The computing device can also receive real-time pressure measurements from a pressure sensor within the pressurizing system. The pressure measurements can indicate pressures in the pressurizing system. The computing device can generate the model based on the predetermined values and the pressure measurements. The computing device can use the model to predict pressures in the pressurizing system over a future period of time. The computing device can analyze aspects of the predicted pressures in the pressurizing system over the future period of time to determine if the blowout preventer is functioning properly.

For example, the computing device can determine if a rate, which can be referred to as the decay rate, at which pressure in the pressurizing system decays during the future period of time is within acceptable limits. An example of the acceptable limits can be between three pounds per square inch (psi) per minute and five psi per minute. If so, the computing device can determine that the blowout preventer is functioning properly. Additionally or alternatively, the computing device can determine if the decay rate will remain within the acceptable limits for an acceptable time period (e.g., at least five minutes). If so, the computing device can determine that the blowout preventer is functioning properly. Additionally or alternatively, the computing device can determine a pressure level in the pressurizing system when the pressure in the blowout preventer is substantially constant or stable (e.g., no longer decaying). If the pressure level is within an acceptable range of pressures, such as between 1,000 psi and 20,000 psi, the computing device can determine that the blowout preventer is functioning properly. The computing device can use any combination of the above criteria to determine of the blowout preventer is functioning properly (or improperly).

Using the model to determine if the blowout preventer is functioning properly can be substantially faster and less expensive than testing the blowout preventer using other methods. For example, if the well operator is only relying on real-time sensor data from the pressure sensor to determine how the pressure in the pressurizing system changes over time, it may take 45 minutes or longer to receive enough pressure measurements from the pressure sensor to make an accurate determination of whether the blowout preventer is functioning properly. And some blowout preventers have multiple sections that need to be individually tested, resulting in many hours of testing. This can be expensive and burdensome for well operators. Further, some laws or regulations require the blowout preventer to be tested weekly, biweekly, or at other short intervals (e.g., every 15 days), thereby requiring well operators test the blowout preventer frequently to great expense. But some examples of the present disclosure can overcome these and other issues by using a limited amount of real-time sensor data to generate a model that can be used to quickly and accurately predict how pressure will change in the pressurizing system over a future time period.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

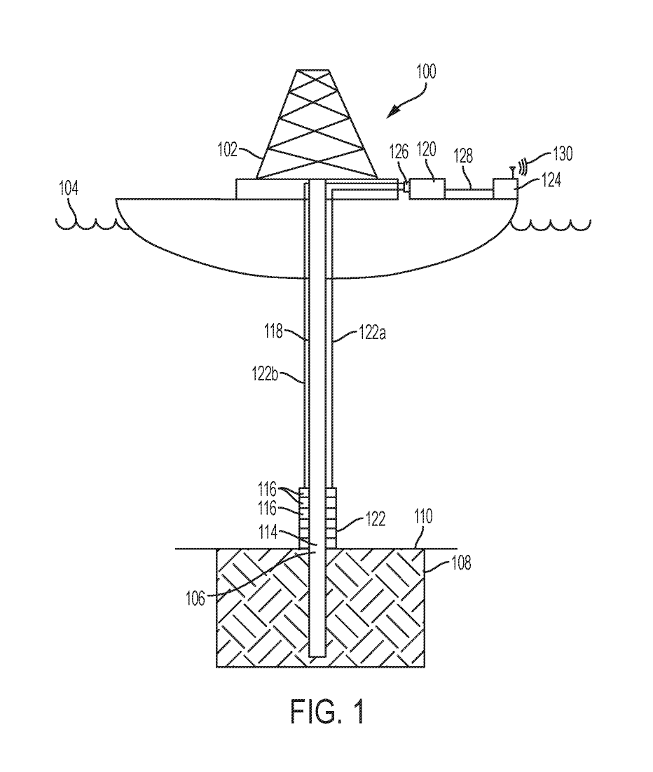

FIG. 1 is a cross-sectional side view of an example of a well system 100 with a computing device 124 for testing a blowout preventer 112 according to some aspects. In this example, the well system 100 includes an offshore drilling rig 102 positioned on a ship, boat, or platform floating at the water's surface 104. The well system 100 also includes a wellbore 106 drilled through a subterranean formation 108 in the seafloor 110 for extracting production fluids, such as hydrocarbons, from the subterranean formation 108. In other examples, some or all of the well system 100 can be onshore or otherwise positioned on land.

The blowout preventer 112 can be positioned at an opening 114 of the wellbore 106. The blowout preventer 112 can control or monitor the pressure and the flow of fluid in the wellbore 106. The blowout preventer 112 can additionally or alternatively seal the wellbore 106 in response to a blowout or other downhole event. This may prevent water surrounding the wellbore 106 from being contaminated. The blowout preventer 112 can include multiple sections 116, and each section can include one or more valves or other devices that can work independently or in combination with one another to perform the above-described functions.

The well system 100 can include a riser 118. A riser 118 can include a tubular that couples the blowout preventer 112 to the drilling rig 102 for allowing fluid, such as production fluid, to flow from the wellbore 106 to the drilling rig 102.

The well system 100 can include a pump 120. The pump 120 can pump or otherwise communicate fluid (e.g., an oil-based mud or a synthetic-based mud) through one or more pipes or lines 122a-b to the blowout preventer 112 to test or otherwise pressurize the blowout preventer 112. The lines 122a-b can include a choke line and a kill line.

The pump 120, the line 122a, the line 122b, the blowout preventer 112, or any combination of these can form a pressurizing system for pressurizing the blowout preventer 112. In some examples, the pressurizing system can be a closed system. A sensor 126, such as a pressure sensor, can be coupled to the pressurizing system for detecting pressure in the pressurizing system (e.g., pressure in the blowout preventer 112). For example, the sensor 126 can be coupled to line 122a, line 122b, pump 120, or blowout preventer 112 for detecting the pressure in the pressurizing system during a test. The sensor 126 can transmit sensor data associated with the pressure to the computing device 124 via a wired interface 128 or a wireless interface 130. The computing device 124 can receive the sensor data and use the sensor data to determine if the blowout preventer 112 is functioning properly.

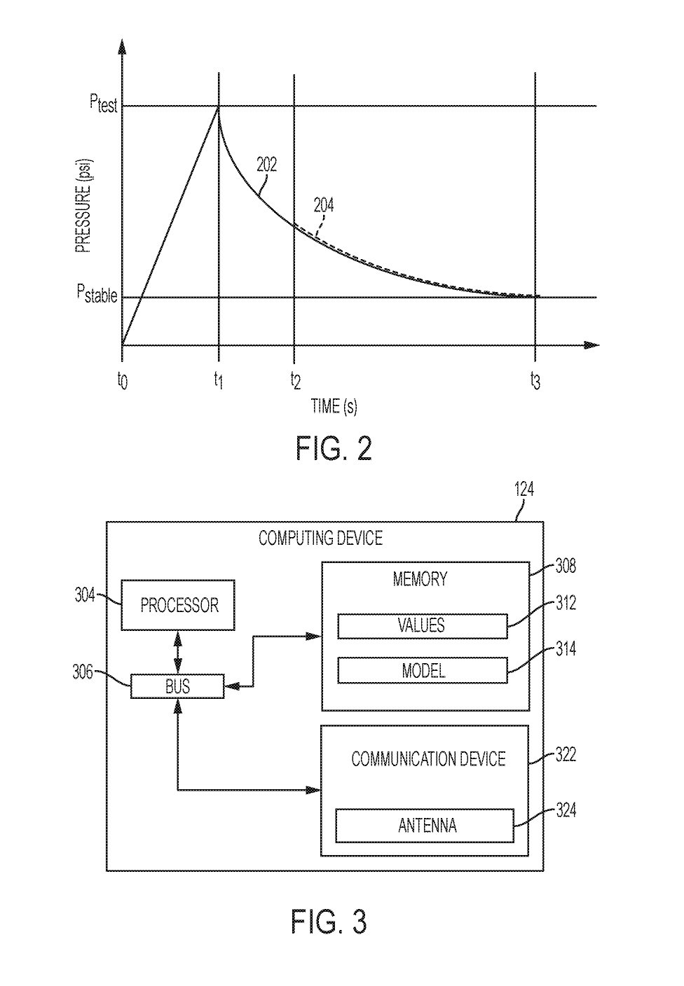

For example, the computing device 124 can cause the pump 120 to pressurize the pressurizing system to a testing pressure level, such as 7,000 psi. As shown in FIG. 2, the increasing line between times t₀ and t₁ can indicate that the pump 120 is pressurizing the pressurizing system to the testing pressure level (Pₜₑₛₜ). The computing device 124 can analyze sensor data from the sensor 126 to determine if the pressure in the pressurizing system has reached the testing pressure level. If so, the computing device 124 can cause the pump 120 to stop pressurizing the pressurizing system. Thereafter, due to thermal cooling and other environmental factors, the pressure in the pressurizing system can decay over time (e.g., as shown between times t₁ and t₃ of FIG. 2). The computing device 124 can analyze sensor data taken at intervals between times t₁ and t₃ and determine, based on the sensor data, if the blowout preventer 112 is functioning properly. For example, if the blowout preventer 112 is functioning properly, the pressure in the pressurizing system can decay at an acceptable rate, such as three to five psi/minute over a five minute time period, and the pressure in the pressurizing system can eventually stabilize to a pressure level (P_{stable}) that is greater than or equal to a target pressure level, such as 6,000 psi. If the blowout preventer 112 is not functioning properly (e.g., if the blowout preventer 112 is leaking), the pressure level in the pressurizing system may decay too quickly, may not stabilize, or may stabilize at a pressure level below the target pressure level. The computing device 124 can determine a rate of decay of the pressure in the pressurizing system, a pressure level at which the pressure in the pressurizing system stabilizes, or both of these, to determine if the blowout preventer 112 is operating properly or malfunctioning.

But it can take a significant amount of time to perform the above-described test. For example, the time period between t₀ and t₃ can be 45 minutes or longer. And this test may need to be performed on every section 116 of the blowout preventer 112, leading to multiple hours of testing in total, which can be expensive and burdensome for well operators. Further, some laws or regulations require the blowout preventer 112 to be tested weekly, biweekly, or at other short intervals, thereby requiring well operators to perform this test frequently to great expense. Some examples of the present disclosure can overcome these and other issues using a model executing on the computing device 124.

For example, the computing device 124 can receive sensor data from the sensor 126 for a limited time period, such the time period between time t₀ and t₂ shown in FIG. 2. The computing device 124 can then use the sensor data to generate a model of the pressure in the pressurizing system over time, as shown by the dashed line 204. The computing device 124 can use the model to predict the rate of decay of the pressure in the pressurizing system, a pressure level at which the pressure in the pressurizing system will stabilize, a time when the pressure in the pressurizing system will stabilize, or any combination of these. For example, the computing device 124 can use the model to predict the pressure level in the pressurizing system at time t₃, and whether the pressure in the pressurizing system will stabilize at time t₃. The computing device 124 can then use the predicted rate of decay, pressure level, time, or any combination of these to determine if the blowout preventer 112 is operating properly. This process can be performed faster, and can require less sensor data, than other methods for testing the blowout preventer 112.

One example of the model can include the equation:

P(t)=A₀+A₁^{-m}^{₁}^{t}A₂^{-m}^{₂}^{t}

where P(t) can be the pressure at time t; A₀, A₁, and A₂ can be values determined by the computing device 124; and m₁ and m₂ can be constants or values determined by the computing device 124. In some examples, m₁ and m₂ can be predetermined values, such as from a previous blowout-preventer test, and may be characteristic of the blowout preventer 112 or the well system 100. This is described in greater detail below. The computing device 124 can use sensor data from the sensor 126 and the above equation to predict how the pressure in the pressurizing system will decay over time, a rate at which the pressure in the pressurizing system will decay over time, a pressure level at which the pressure in the pressurizing system will stabilize, a time when the pressure in the pressurizing system will stabilize, or any combination of these.

For example, referring to FIGS. 1-2 together, the computing device 124 can receive multiple sensor measurements between times t₁ and t₂. Each sensor measurement can indicate a pressure in the pressurizing system at a point in time between t₁ and t₂. The computing device 124 can use each individual sensor measurement as a value for P(t), and determine values for A₀, A₁, and A₂ (and m₁ and m₂, if these values were not previously determined based on a previous blowout-preventer test) that satisfy the above equation. The computing device 124 can use a Levenberg-Marquardt algorithm or another optimization technique for determining the values for A₀, A₁, and A₂ (and m₁ and m₂, if necessary). The computing device 124 can iterate this process for each sensor measurement taken between t₁ and t₂, until the computing device 124 has determined substantially stable values for A₀, A₁, and A₂ (and m₁ and m₂, if necessary) that substantially satisfy (e.g., satisfy within a tolerance range) the equation for all the sensor measurements taken between t₁ and t₂. The computing device 124 can then insert the determined values for A₀, A₁, and A₂ (and m₁ and m₂) into the equation, and use the equation to predict pressure values (P(t)) at future times. This can allow the computing device 124 to plot or otherwise predict how the pressure in the pressurizing system will decay over time, a rate at which the pressure in the pressurizing system will decay over time, a pressure level at which the pressure in the pressurizing system will stabilize, a time when the pressure in the pressurizing system will stabilize, or any combination of these. If the computing device 124 determines that the pressure in the pressurizing system will decay at a rate that is within an acceptable range, that the pressure in the pressurizing system will stabilize to a pressure level that is within an acceptable range of pressures, that the pressure in the pressurizing system will stabilize at a time that is within an acceptable range of times, or any combination of these, the computing device 124 can determine that the blowout preventer 112 is functioning properly. Otherwise, the computing device 124 can determine that the blowout preventer 112 is malfunctioning.

FIG. 3 is a block diagram of an example of a computing device 124 for testing a blowout preventer according to some aspects. The computing device 124 can include a processor 304, bus 306, memory 308, a communication device 322, etc. In some examples, the components shown in FIG. 3 (e.g., the processor 304, bus 306, communication device 322, and memory 308) can be integrated into a single structure, such as a single housing. In other examples, the components shown in FIG. 3 can be distributed (e.g., in separate housings) and in electrical communication with each other.

The processor 304 can execute one or more operations for implementing any of the features of the present disclosure. The processor 304 can execute instructions stored in the memory 308 to perform the operations. The processor 304 can include one processing device or multiple processing devices. Non-limiting examples of the processor 304 include a Field-Programmable Gate Array (“FPGA”), an application-specific integrated circuit (“ASIC”), a microprocessor, etc.

The processor 304 can be communicatively coupled to the memory 308 via the bus 306. The non-volatile memory 308 may include any type of memory device that retains stored information when powered off. Non-limiting examples of the memory 308 include electrically erasable and programmable read-only memory (“EEPROM”), flash memory, or any other type of non-volatile memory. In some examples, at least some of the memory 308 can include a medium from which the processor 304 can read instructions. A computer-readable medium can include electronic, optical, magnetic, or other storage devices capable of providing the processor 304 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

In some examples, the memory 308 can include a model 314. The model 314 can include one or more algorithms, such as the equation discussed with respect to FIGS. 1-2. The model 314 can be used to predict a pressure in a pressurizing system over a period of time.

The memory 308 can also include one or more predetermined values 312 for use with the model 314. For example, the values 312 can include predetermined values for m₁, m₂, or both, which may have been determined from a previous blowout-preventer test. Additionally or alternatively, the values 312 can include predetermined values for A₀, A₁, A₂, or any combination of these, which may have been determined from a previous blowout-preventer test.

The computing device 124 can be in electrical communication with the communication device 322. The communication device 322 can include or can be coupled to an antenna 324. In some examples, part of the communication device 322 can be implemented in software. For example, the communication device 322 can include instructions stored in memory 308.

The communication device 322 can receive signals from remote devices (e.g., the sensor 126 of FIG. 1) and transmit signals to remote devices. For example, to transmit data to a remote device, the processor 304 can transmit one or more signals to the communication device 322. The communication device 322 can receive the signals from the processor 304 and amplify, filter, modulate, frequency shift, and otherwise manipulate the signals. The communication device 322 can transmit the manipulated signals to the antenna 324, which can responsively generate wireless signals that carry the data. As another example, the communication device 322 can transmit data via a wired interface, such as a wireline.

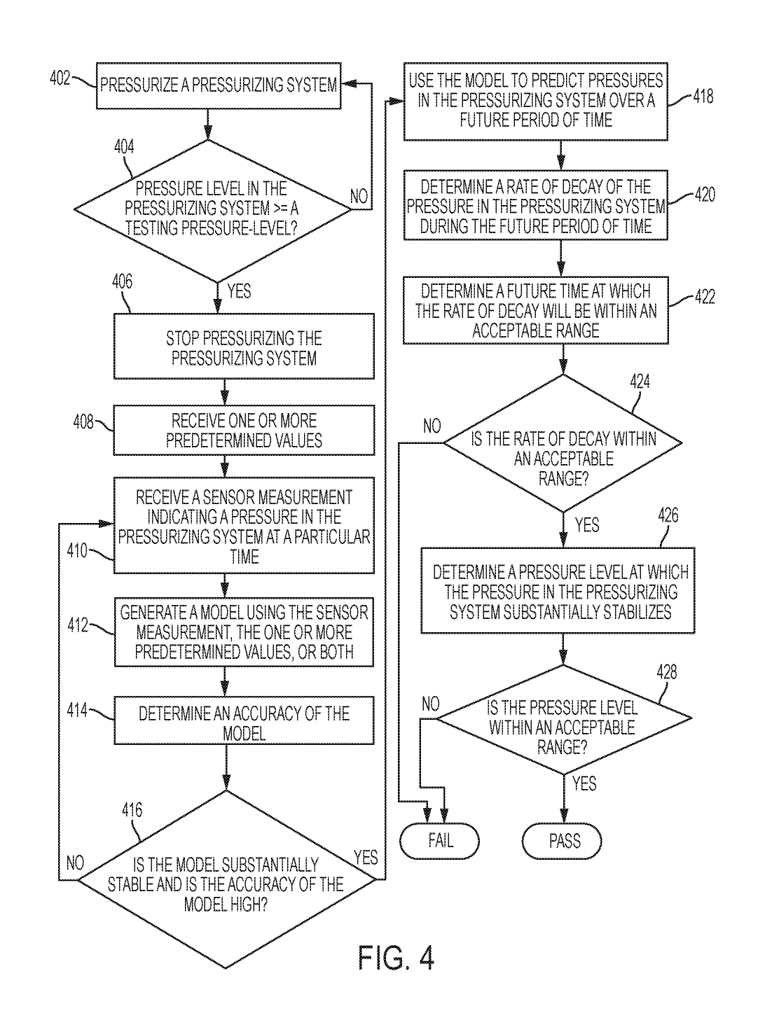

FIG. 4 is a flow chart showing an example of a process for testing a blowout preventer according to some aspects. Some examples can include more, fewer, or different steps than the steps depicted in FIG. 4. Also, some examples can implement the steps of the process in a different order. The steps below are described with reference to components described above with regard to FIG. 1, but other implementations are possible.

In block 402, the computing device 124 causes the pump 120 to pressurize a pressurizing system. The pressurizing system can include at least one of the pump 120, the line 122a, the line 122b, or the blowout preventer 112. For example, the computing device 124 can transmit power or a command to the pump 120, or manipulate a power source, to cause the pump 120 to pump fluid through the pressurizing system to pressurize the pressurizing system. In some examples, the fluid can be an oil-based mud or a synthetic-based mud.

In block 404, the computing device 124 determines if the pressure level in the pressurizing system is greater than or equal to a testing pressure-level, such as 7,000 psi. For example, the computing device 124 can receive sensor signals from the sensor 126, where the sensor signals indicate a pressure level in the pressurizing system. The computing device 124 can analyze the sensor signals to determine if the pressure level in the pressurizing system is greater than or equal to the testing pressure-level. If the computing device 124 determines that the pressure level in the pressurizing system is less than the testing pressure-level, the computing device 124 can continue to cause the pump 120 to pressurize the pressurizing system. Otherwise, the process can continue to block 406.

In block 406, the computing device 124 causes the pump 120 to stop pressurizing the pressurizing system. For example, the computing device 124 can stop transmitting power to the pump 120, transmit a command to the pump 120, or manipulate a power source to cause the pump 120 to stop pressurizing the pressurizing system.

In block 408, the computing device 124 receives one or more predetermined values, such as values for m₁ and m₂ of a model. The model can be at least partially based on a thermal-cooling characteristic of the pressurizing system or a wellbore 106 associated with the blowout preventer 112. In some examples, the computing device 124 can receive the predetermined values from a remote computing device (e.g., that is offsite). In other examples, the computing device 124 can receive the predetermined values from memory. In such examples, the computing device 124 may have previously determined or received the predetermined values and stored the values in memory.

For example, the computing device 124 can determine the predetermined values based on information from a previous blowout-preventer test. The previous blowout-preventer test can include pressurizing the pressurizing system until the pressure in the pressurizing system reaches a testing pressure-level and then taking pressure measurements with a sensor 126 as the pressure in the pressurizing system decays. In some examples, the computing device 124 can determine a curve, trend, or other characteristic associated with the pressure measurements. The computing device 124 can use the curve, trend, or other characteristic to determine the predetermined values (e.g., the values for m₁ and m₂). In some examples, the computing device 124 can estimate the predetermined values using a non-linear regression method, such as the Levenberg-Marquardt method, in conjunction with the pressure measurements and the equation discussed with respect to FIGS. 1-2. The computing device 124 can then store the predetermined values in memory.

In block 410, the computing device 124 receives a sensor measurement from the sensor 126. The sensor measurement can indicate a pressure in the pressurizing system at a particular time.

In block 412, the computing device 124 generates a model using the sensor measurement, the one or more predetermined values, or both of these. For example, the computing device 124 can use the sensor measurement as a value for P(t) in the model, and determine values for A₀, A₁, A₂, m₁, m₂, or any combination of these, that satisfy the model. The computing device 124 can use a Levenberg-Marquardt algorithm or another optimization technique for determining the values for the model (e.g., A₀, A₁, A₂, m₁, m₂, or any combination of these). In some examples, the model can represent a relationship between pressure in the pressurizing system and time.

In block 414, the computing device 124 determines an accuracy of the model. For example, the computing device 124 can determine an estimated pressure at time t (i.e., a value for P(t)) by plugging some or all of the determined values for A₀, A₁, A₂, m₁, and m₂ into the above-described equation. Time t can be a time for which the computing device 124 has received a sensor measurement of the pressure in the pressurizing system. The computing device 124 can determine a root-mean-squared error between the estimated pressure at time t determined using the model and the pressure at time t determined from the sensor measurement. The computing device 124 can use the root-mean-squared error as an indicator of the accuracy of the model.

In some examples, blocks 410-414 can be iterated for multiple sensor measurements over a time period. For example, the computing device 124 can receive multiple sensor measurements indicating multiple pressures in the pressurizing system over a time period. If the blowout preventer 112 is functioning properly, the values for the model (e.g., A₀, A₁, A₂, m₁, m₂, or any combination of these) can become substantially stable after several iterations. The values for the model can be considered substantially stable if the values remain substantially constant (e.g., within a tolerance range of 5%) over multiple iterations. Additionally or alternatively, if the blowout preventer 112 is functioning properly, the accuracy of the model can be high (e.g., above a predetermined quality-threshold). In some examples, the computing device 124 can determine if the some or all of the values for the model are substantially stable and the accuracy of the model is high, as shown in block 416. If so, the process continues to block 418. Otherwise, the process can return to block 410.

In block 418, the computing device 124 uses the model to predict pressures in the pressurizing system over a future period of time. For example, the computing device 124 can plug different future times (t) into the above-described equation to determine pressures in the pressurizing system at those future times.

In block 420, the computing device 124 determines a rate of decay of the pressure in the pressurizing system during the future period of time. For example, the computing device 124 can use the model to predict changes in the pressure in the pressurizing system over the future period of time. The computing device 124 can then determine a rate at which the pressure in the pressurizing system will change over the future period of time and use the rate of change as the rate of decay.

In block 422, the computing device 124 determines a future time at which the rate of decay will be within an acceptable range. In some examples, the acceptable range can be between three psi/minute and six psi/minute. The computing device 124 can also determine if the rate of decay will remain in the acceptable range for a predetermined period of time (e.g., at least three minutes).

In block 424, the computing device 124 determines if the rate of decay is (or will be) within an acceptable range. In some examples, if the computing device 124 determines that the rate of decay will never (during the future period of time) be within the acceptable range, the computing device 124 can determine that the blowout preventer 112 failed the test. In some examples, if the computing device 124 determines that the rate of decay is (or will be) within an acceptable range, the computing device 124 can determine that the blowout preventer 112 passed the test, or the process can continue to block 426.

In block 426, the computing device 124 determines a pressure level at which the pressure in the pressurizing system will substantially stabilize. The pressure level can be considered substantially stable if the pressure level remains substantially constant (e.g., within a tolerance range of 5%) over a time period. For example, the computing device 124 can use the model to predict pressures in the pressurizing system over a future period of time. The computing device 124 can analyze the predicted pressures in the pressurizing system to determine if the pressure in the pressurizing system will ever (during the future period of time) become substantially stable. If so, the computing device 124 can determine the pressure level at which the pressure in the pressurizing system becomes substantially stable.

In block 428, the computing device 124 determines if the pressure level (at which the pressure in the pressurizing system is substantially stable) is within an acceptable range of pressures. An example of the acceptable range can be between 5,900 psi and 6,100 psi. If the computing device 124 determines that the pressure level is within the acceptable range of pressures, the computing device 124 can determine that the blowout preventer 112 passed the test. Otherwise, the computing device 124 can determine that the blowout preventer 112 failed the test.

In some aspects, systems, computer-readable mediums, and methods for analyzing a blowout preventer are provided according to one or more of the following examples:

### Example #1

A system can include a pressure sensor that is positionable in a pressurization subsystem for pressurizing a blowout preventer. The pressure sensor can be for detecting pressure in the pressurization subsystem. The system can include a computing device communicatively coupled to the pressure sensor. The computing device can include a processing device and a memory device on which instructions are stored. The instructions can cause the processing device to receive multiple predetermined values associated with pressure changes in the pressurization subsystem over time. The instructions can cause the processing device to receive, from the pressure sensor, multiple pressure measurements indicating multiple pressures in the pressurization subsystem over a time period. The instructions can cause the processing device to generate, based on the multiple predetermined values and the multiple pressure measurements, a model representing a relationship between pressure in the pressurization subsystem and time. The instructions can cause the processing device to predict, using the model, pressures in the pressurization subsystem over a future period of time that is subsequent to the time period.

### Example #2

The system of Example #1 may feature the memory device further including instructions for causing the processing device to determine, by analyzing the predicted pressures in the pressurization subsystem over the future period of time, a rate of decay of the pressure in the pressurization subsystem during the future period of time. The instructions may also cause the processing device to determine that the rate of decay is within a range of acceptable decay rates.

### Example #3

The system of Example #2 may feature the range of acceptable decay rates being between three pounds per square inch (psi) per minute and five psi per minute.

### Example #4

The system of any of Examples #2-3 may feature the memory device further including instructions for causing the processing device to determine, by analyzing the predicted pressures in the pressurization subsystem over the future period of time, that the rate of decay will be within the range of acceptable decay rates for an acceptable period of time that is at least five minutes long.

### Example #5

The system of any of Examples #1-4 may feature the memory device further including instructions for causing the processing device to determine, by analyzing the predicted pressures in the pressurization subsystem over the future period of time, a pressure level at which the pressure in the pressurization subsystem is substantially stable. The instructions may also cause the processing device to determine that the pressure level is within an acceptable range of pressures.

### Example #6

The system of Example #5 may feature the acceptable range of pressures being between 1,000 psi and 20,000 psi.

### Example #7

The system of any of Examples #1-6 may feature the model being based on a thermal-cooling characteristic of the pressurization subsystem.

### Example #8

A non-transitory computer-readable medium can store instructions executable by a processing device. The instructions can cause the processing device to receive multiple predetermined values associated with pressure changes in a pressurization subsystem over time. The pressurization subsystem can be for pressurizing a blowout preventer in a well system. The instructions can cause the processing device to receive, from a pressure sensor, multiple pressure measurements indicating multiple pressures in the pressurization subsystem over a time period. The instructions can cause the processing device to generate, based on the multiple predetermined values and the multiple pressure measurements, a model representing a relationship between pressure in the pressurization subsystem and time. The instructions can cause the processing device to predict, using the model, pressures in the pressurization subsystem over a future period of time that is subsequent to the time period.

### Example #9

The non-transitory computer-readable medium of Example #8 may feature instructions for causing the processing device to determine, by analyzing the predicted pressures in the pressurization subsystem over the future period of time, that a rate of decay of the pressure in the pressurization subsystem will remain within a range of acceptable decay rates for an acceptable period of time.

### Example #10

The non-transitory computer-readable medium of Example #9 may feature the range of acceptable decay rates being between three psi per minute and 5 psi per minute, and the acceptable period of time being at least five minutes.

### Example #11

The non-transitory computer-readable medium of any of Examples #8-10 may feature instructions for causing the processing device to, prior to the time period, cause a pump of the pressurization subsystem to communicate an oil-based mud or a synthetic-based mud through the pressurization subsystem to pressurize the pressurization subsystem.

### Example #12

The non-transitory computer-readable medium of any of Examples #8-11 may feature instructions for causing the processing device to determine, by analyzing the predicted pressures in the pressurization subsystem over the future period of time, a pressure level at which the pressure in the pressurization subsystem is substantially stable. The instructions may also cause the processing device to determine that the pressure level is within an acceptable range of pressures.

### Example #13

The non-transitory computer-readable medium of Example #12 may feature the acceptable range of pressures being between 1,000 psi and 20,000 psi.

### Example #14

The non-transitory computer-readable medium of any of Examples #8-13 may feature the model being based on a thermal-cooling characteristic of the blowout preventer.

### Example #15

A method can include receiving, by a computing device, multiple predetermined values associated with pressure changes in a pressurization subsystem over time. The pressurization subsystem can be for pressurizing a blowout preventer in a well system. The method can include receiving, by the computing device and from a pressure sensor, multiple pressure measurements indicating multiple pressures in the pressurization subsystem over a time period. The method can include generating, by the computing device and based on the multiple predetermined values and the multiple pressure measurements, a model representing a relationship between pressure in the pressurization subsystem and time. The method can include predicting, by the computing device and using the model, pressures in the pressurization subsystem over a future period of time that is subsequent to the time period.

### Example #16

The method of Example #15 may feature determining, by analyzing the predicted pressures in the pressurization subsystem over the future period of time, that a rate of decay of the pressure in the pressurization subsystem is less than an acceptable decay rate for an acceptable period of time.

### Example #17

The method of Example #16 may feature the acceptable decay rate being less than five psi per minute, and the acceptable period of time being at least five minutes.

### Example #18

The method of any of Examples #15-17 may feature causing, prior to the time period, a pump of the pressurization subsystem to pump an oil-based mud or a synthetic-based mud through the pressurization subsystem to pressurize the pressurization subsystem.

### Example #19

The method of any of Examples #15-18 may feature determining, by analyzing the predicted pressures in the pressurization subsystem over the future period of time, a pressure level at which the pressure in the pressurization subsystem is substantially stable. The method may also feature determining that the pressure level is within an acceptable range of pressures.

### Example #20

The method of Example #19 may feature the acceptable range of pressures being between 1,000 psi and 20,000 psi. The method may feature the model being based on a thermal-cooling characteristic of the blowout preventer.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A system comprising:
a pressure sensor that is positionable in a pressurization subsystem for pressurizing a blowout preventer, the pressure sensor for detecting pressure in the pressurization subsystem; and
a computing device communicatively coupled to the pressure sensor and including a processing device and a memory device on which instructions are stored for causing the processing device to:
receive a plurality of predetermined values associated with pressure changes in the pressurization subsystem over time;
receive, from the pressure sensor, a plurality of pressure measurements indicating a plurality of pressures in the pressurization subsystem over a time period;
generate, based on the plurality of predetermined values and the plurality of pressure measurements, a model representing a relationship between pressure in the pressurization subsystem and time; and
predict, using the model, pressures in the pressurization subsystem over a future period of time that is subsequent to the time period.

2. The system of claim 1, wherein the memory device further includes instructions for causing the processing device to:
determine, by analyzing the predicted pressures in the pressurization subsystem over the future period of time, a rate of decay of the pressure in the pressurization subsystem during the future period of time; and
determine that the rate of decay is within a range of acceptable decay rates.

3. The system of claim 2, wherein the range of acceptable decay rates is between three pounds per square inch (psi) per minute and five psi per minute.

4. The system of claim 3, wherein the memory device further includes instructions for causing the processing device to:
determine, by analyzing the predicted pressures in the pressurization subsystem over the future period of time, that the rate of decay will be within the range of acceptable decay rates for an acceptable period of time that is at least five minutes long.

5. The system of claim 1, wherein the memory device further includes instructions for causing the processing device to:
determine, by analyzing the predicted pressures in the pressurization subsystem over the future period of time, a pressure level at which the pressure in the pressurization subsystem is substantially stable; and
determine that the pressure level is within an acceptable range of pressures.

6. The system of claim 5, wherein the acceptable range of pressures is between 1,000 psi and 20,000 psi.

7. The system of claim 1, wherein the model is based on a thermal-cooling characteristic of the pressurization subsystem.

8. A non-transitory computer-readable medium in which instructions executable by a processing device are stored for causing the processing device to:
receive a plurality of predetermined values associated with pressure changes in a pressurization subsystem over time, the pressurization subsystem being for pressurizing a blowout preventer in a well system;
receive, from a pressure sensor, a plurality of pressure measurements indicating a plurality of pressures in the pressurization subsystem over a time period;
generate, based on the plurality of predetermined values and the plurality of pressure measurements, a model representing a relationship between pressure in the pressurization subsystem and time; and
predict, using the model, pressures in the pressurization subsystem over a future period of time that is subsequent to the time period.

9. The non-transitory computer-readable medium of claim 8, further comprising instructions for causing the processing device to determine, by analyzing the predicted pressures in the pressurization subsystem over the future period of time, that a rate of decay of the pressure in the pressurization subsystem will remain within a range of acceptable decay rates for an acceptable period of time.

10. The non-transitory computer-readable medium of claim 9, wherein the range of acceptable decay rates is between three psi per minute and 5 psi per minute, and the acceptable period of time is at least five minutes.

11. The non-transitory computer-readable medium of claim 8, further comprising instructions for causing the processing device to, prior to the time period, cause a pump of the pressurization subsystem to communicate an oil-based mud or a synthetic-based mud through the pressurization subsystem to pressurize the pressurization subsystem.

12. The non-transitory computer-readable medium of claim 8, further comprising instructions for causing the processing device to:
determine, by analyzing the predicted pressures in the pressurization subsystem over the future period of time, a pressure level at which the pressure in the pressurization subsystem is substantially stable; and
determine that the pressure level is within an acceptable range of pressures.

13. The non-transitory computer-readable medium of claim 12, wherein the acceptable range of pressures is between 1,000 psi and 20,000 psi.

14. The non-transitory computer-readable medium of claim 8, wherein the model is based on a thermal-cooling characteristic of the blowout preventer.

15. A method comprising:
receiving, by a computing device, a plurality of predetermined values associated with pressure changes in a pressurization subsystem over time, the pressurization subsystem being for pressurizing a blowout preventer in a well system;
receiving, by the computing device and from a pressure sensor, a plurality of pressure measurements indicating a plurality of pressures in the pressurization subsystem over a time period;
generating, by the computing device and based on the plurality of predetermined values and the plurality of pressure measurements, a model representing a relationship between pressure in the pressurization subsystem and time; and
predicting, by the computing device and using the model, pressures in the pressurization subsystem over a future period of time that is subsequent to the time period.

16. The method of claim 15, further comprising determining, by analyzing the predicted pressures in the pressurization subsystem over the future period of time, that a rate of decay of the pressure in the pressurization subsystem is less than an acceptable decay rate for an acceptable period of time.

17. The method of claim 16, wherein the acceptable decay rate is less than five psi per minute, and the acceptable period of time is at least five minutes.

18. The method of claim 15, further comprising causing, prior to the time period, a pump of the pressurization subsystem to pump an oil-based mud or a synthetic-based mud through the pressurization subsystem to pressurize the pressurization subsystem.

19. The method of claim 15, further comprising:
determining, by analyzing the predicted pressures in the pressurization subsystem over the future period of time, a pressure level at which the pressure in the pressurization subsystem is substantially stable; and
determining that the pressure level is within an acceptable range of pressures.

20. The method of claim 19, wherein the acceptable range of pressures is between 1,000 psi and 20,000 psi, and wherein the model is based on a thermal-cooling characteristic of the blowout preventer.
